(19) United States
(12) Patent Application Publication
(10) Pub. No.: US 2003/0195760 A1
(43) Pub. Date: Oct. 16, 2003

(54) System for providing services to visitors to entertainment parks and content unit and portable service device therefor

(76) Inventors: Jin-Hong Kim, Seoul (KR); Yun-Il Kook, Seoul (KR)

Correspondence Address: CHA & REITER, 411 HACKENSACK AVE, 9TH FLOOR, HACKENSACK, NJ, 07601, US

(21) Appl. No.: 10/188,384

(22) Filed: Jul. 2, 2002

(30) Foreign Application Priority Data
Apr. 13, 2002 (KR) 2002-20252

(51) Int. Cl. G06F 17/60

(52) U.S. Cl. 705/1

(57) ABSTRACT

The present invention provides a system for enabling services to a visitor to an entertainment park. In particular, the present invention increases the visiting time, as well as spending, of a visitor to an entertainment park while maximizing the visitor's satisfaction and creating new demand for both park services and return visits. The system includes a content unit and portable service device. The content unit includes a memory device for storing the content and a connection unit for allowing the memory device to be accessed from the external device. The portable service device includes a content access unit for accessing the content unit provided in the portable service device; an image input/output unit for displaying an image or capturing an image to input the captured image; an audio input/output unit for inputting or outputting audio; an input tool for inputting various commands from the visitor; and a controller for controlling the content access unit to read the content and outputting an image or audio corresponding to the content, or for inputting an image or audio to store the inputted image or audio in the content unit using the content access unit.

### CLAIM OF PRIORITY

This application claims priority to an application entitled “SYSTEM FOR PROVIDING NEEDED SERVICES TO VISITORS TO ENTERTAINMENT PARKS AND CONTENT UNIT AND PORTABLE SERVICE DEVICE THEREFOR”, filed in the Korean Industrial Property Office on Apr. 13, 2002 and assigned Serial No. 2002-20252.

### BACKGROUND OF THE INVENTION

1. Field of the Invention

The present invention relates to a method for maximizing customer satisfaction while visiting an entertainment park, and more particularly to a system for providing services to increase customer satisfaction.

2. Description of the Related Art

When a customer (referred to as a “visitor” in this specification) is excited on a certain occasion (S100), and wants to escape from his/her daily routine, he/she may wish to visit an entertainment park such as Disneyland in America, Japan or the like, or Everland in Korea, with the expectation of obtaining a novel experience (S102), as shown in FIG. 1.

The visitor may be pleased with his/her enjoyable experience in the entertainment park and retain the experience in his/her memory for some time after returning home (S104). There is a rising tendency for a visitor who has visited an entertainment park to re-visit it. According to a study, the percentage of people who visited Disneyland in Japan just one time against all visitors thereto is only 2.5%, while the percentage of persons who have visited it more than 30 times is 18%.

As described above, visitors tend to re-visit entertainment parks, to escape their daily routine and obtain pleasurable or special experiences therein. On the other hand, operators of the entertainment park hope to attract more visitors and expect that the ratio of returning visitors will increase. Operators also want the time visitors stay, as well as the amount visitors spend at such entertainment parks to increase, while maximizing a visitor's satisfaction and creating new demand. Accordingly, operators are required to make an effort to give the visitors a good impression of the experiences in the entertainment park, thereby raising the ratio of returning visitors.

### SUMMARY OF THE INVENTION

The present invention reduces or overcomes many of the above problems, and one aspect of the present invention provides a system which increases both the visiting time and monetary spending of a visitor to an entertainment park while maximizing the visitor's satisfaction, as well as creating new demand for services, products and use of park facilities. In addition, the present invention provides a content unit and portable service device for the system.

Another aspect of the present invention provides a service system in which a visitor to an entertainment park receives a positive impression of their experiences in the entertainment park, thereby increasing the ratio of returning visitors.

In accordance with principals of the present invention, a service system is provided comprising a content unit for storing contents satisfying any one of various needs of a visitor in the entertainment park, a content access unit for accessing the provided content unit, and a portable service device for providing the visitor with the contents stored in the content unit in response to a command from the visitor. Preferably, the service system may further comprise a kiosk for accessing the portable service device and providing contents to the portable service device. The service system may further comprise a base station, such as a Bluetooth base station, for transmitting multimedia data using various communication protocols, such as Bluetooth. The service system may further comprise a personal computer (PC) installed in a home of the visitor, and a content access unit connected to the PC and provided with the content unit, the content access unit allowing the PC to access the content unit.

In one illustrative embodiment, the content unit includes a memory device for storing contents satisfying any one of various needs of the visitor in the entertainment park, and a connection unit for allowing access to the memory device from the external device. In a preferred embodiment, the content unit is manufactured in a souvenir form, such as coin or token shaped device, so that the visitor can use the content unit conveniently and remember his/her experience in the park specifically.

Preferably, the portable service device includes (1) a content access unit for accessing the content unit provided in the portable service device, (2) an image input/output unit for displaying an image or capturing an image to input the captured image, (3) an audio input/output unit for inputting or outputting audio, (4) an input tool for inputting various commands from the visitor, and (5) a controller for controlling the content access unit to read the contents stored in the content unit in response to the commands inputted through the input tool and outputting an image or audio corresponding to the read contents through the image input/output unit or the audio input/output unit, or for inputting an image or audio to store the inputted image or audio in the content unit using the content access unit. The portable service device may further include a Bluetooth module for receiving the multimedia data from the Bluetooth base station using the Bluetooth communication. The portable service device may further include a kiosk connection unit for accessing the kiosk and being provided with the contents provided from the kiosk.

### BRIEF DESCRIPTION OF THE DRAWINGS

The present invention will be more clearly understood from the following detailed description taken in conjunction with the accompanying drawings, in which:

FIG. 1 is view illustrating a general example of an entertainment park visiting cycle of a visitor;

FIG. 2 is a block diagram showing a service system in accordance with a preferred embodiment of the present invention;

FIG. 3 is a block diagram showing a content unit in accordance with a preferred embodiment of the present invention;

FIG. 4 is a block diagram showing a portable service device in accordance with a preferred embodiment of the present invention;

FIG. 5 is a view illustrating an example of a business model in accordance with the present invention; and

FIG. 6 is a graph illustrating variation in satisfaction associated with a visit to an entertainment park.

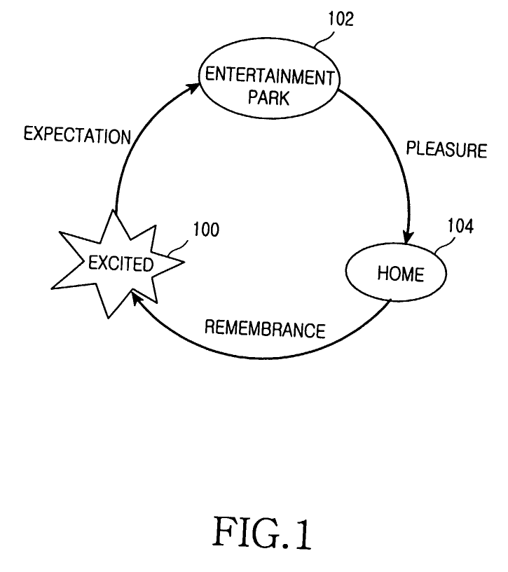

### DETAILED DESCRIPTION OF THE PREFERRED EMBODIMENTS

In the following description of the present invention, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments that depart from these specific details. Moreover, it will be recognized that certain aspects of the figures are simplified for explanation purposes and that the full system environment for the invention will comprise many known functions and configurations all of which need not be shown here. In the drawings, the same or similar elements are denoted by the same reference numerals even though they are depicted in different drawings.

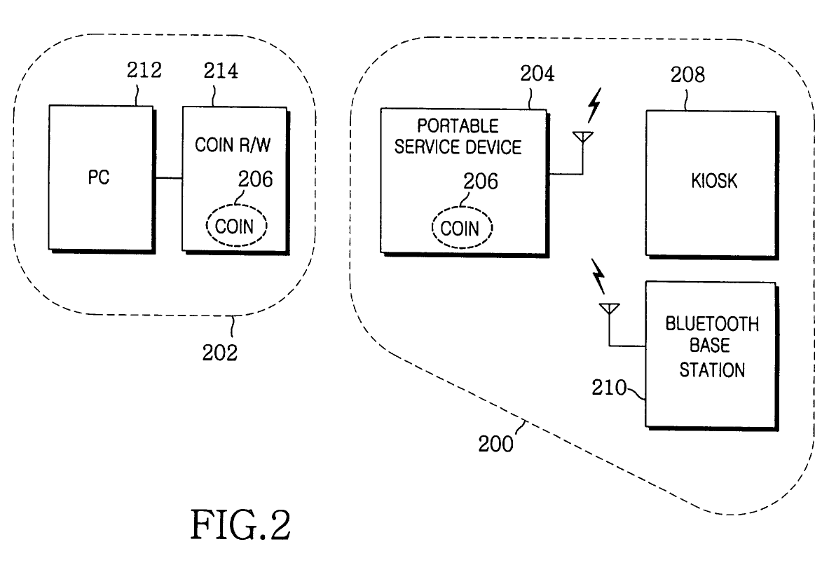

FIG. 2 shows, in block form, a service system in accordance with a preferred embodiment of the present invention. The service system includes a kiosk 208 and a Bluetooth base station 210 in an entertainment park 200. A visitor carries a portable service device 204 for providing services to satisfy various needs in the entertainment park 200 using coin 206 provided therein. Coin 206 is a content unit, which is produced in the form of a coin-shaped souvenir. For this reason, this component is referred to as “coin”.

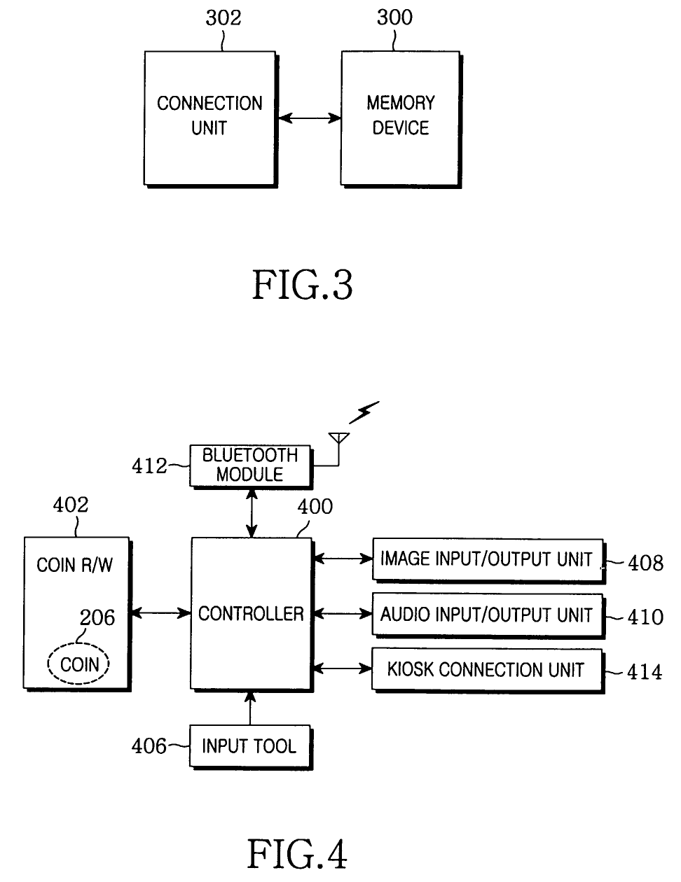

As shown in FIG. 3, coin 206 includes a memory device 300 and connection unit 302. The memory device 300 is provided in the coin 206 to store contents for satisfying at least one of various needs a visitor may require while in the entertainment park. The memory device 300 may include a semiconductor memory chip. The connection unit 302 acts to allow the portable service device 204 to access the memory device 300 when the portable service device 204 is provided with the coin 206. The coin 206 stores various contents for satisfying the respective needs of the visitor, which may arise while he/she moves from place to place in the entertainment park. Importantly, the coin 206 can be used as a solution corresponding to each need and as a coin-shaped intermediary between the visitor and the park. The coin 206 can be any one of various types according to the respective content of the coin, which content corresponds to a set of needs of a visitor. For example, by analyzing the needs of the visitor, such as a desire to escape his/her daily routine, a novel experience can be promoted and gained in the entertainment park. For example, the coin 206 can be implemented with content as an “event information coin” providing information about a current day's events in the park, a “guide coin” providing information about a recommended course for reducing walking distance, a “game coin” providing games needed to spend waiting time pleasantly, a “story coin” providing orally narrated fairly tales for children, and a “my coin” used for storage of visitor's pictures. The visitor can obtain (e.g. buy) coins, as desired and as required according to his/her needs and use each of the coins under the condition that the corresponding coin is provided, in the portable service device 204.

Referring now to FIG. 4, the portable service device 204 includes a controller 400, a coin reader/writer (R/W) 402, input tool 406, image input/output unit 408, audio input/output unit, Bluetooth module 412 and kiosk connection unit 414. With this construction, the portable service device 204 provides contents stored in the coin 206 to the visitor in response to a command input. The coin R/W 402 is a content access unit, which accesses the content stored in the coin 206 provided in the portable device 204, under the control of the controller 400. The input tool 406 inputs various commands from the visitor. The image input/output unit 408 includes a black-and-white or color display and a digital camera. The image input/output unit 408 displays an image or captures an image and then inputs the captured image, under the control of the controller 400. The audio input/output unit 410 includes a microphone and speaker and acts to input or output audio. The controller 400 controls the coin R/W 402 to read the content stored in the coin 206 according to the command input through the input tool 406. The controller 400 then controls the image or audio input/output units 408 and 410 to output an image or audio, or to input an image or audio to store the inputted image or audio in the coin 206 using the coin R/W 402. Further, the controller 400 receives multimedia data from the Bluetooth base station 210 through the Bluetooth module 412 using a Bluetooth communication. The visitor can provide the coin 206 to the portable service device 204, and according to content stored in the coin 206, use a service such as a voice or image service, personal information management system (PIMS), picture storage, game or the like.

Further, the visitor can connect the portable service device 204 to the kiosk 208 through the kiosk connection unit 414 provided in the portable service device 204 in order to be provided with various information or entertainment contents in any place in the entertainment park 200.

Furthermore, the visitor can connect the coin R/W 214 to a personal computer (PC) 212 in his/her home 202. Then, the visitor provides the coin R/W 214 with the coin 206 having been used in the park 200 to access the content's of coin 206 through the PC 212, thereby allowing the visitor to recall experiences of park 200. Moreover, the visitor keeps the coin 206 as a souvenir with the experiences in the entertainment park 200 and thus can recall these events and the overall pleasurable experience to his/her memory anytime thereafter and thereby may be induced to visit the park again.

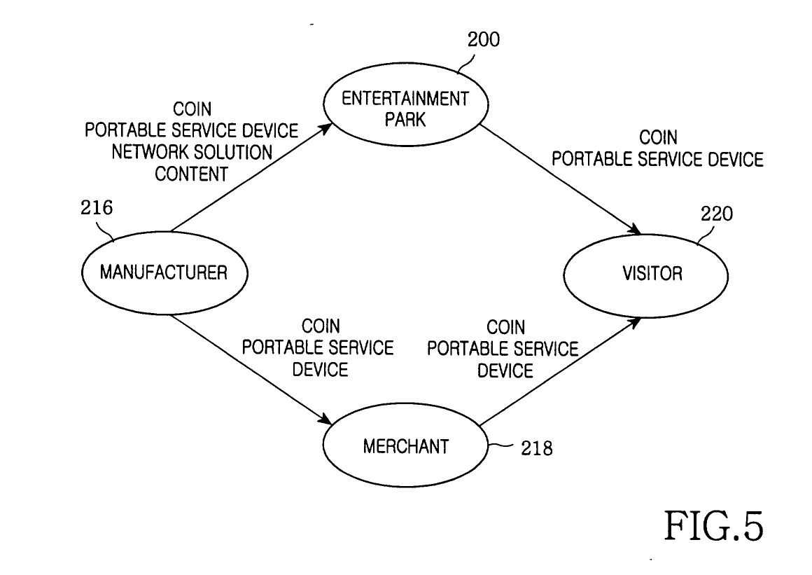

FIG. 5 shows an example of a business model according to the present invention. Referring to this drawing, a manufacturer 216 sells the entertainment park 200, the coin 206, the portable service device 204, a network solution and contents. In addition, the manufacturer 216sells a merchant 218, the coin 206 and portable service device 204. Either the entertainment park 200 or the merchant 218 sells a visitor 220, the coin 206. The portable service device 204 is rented or sold to the visitor by either the entertainment park 200 or the merchant 218.

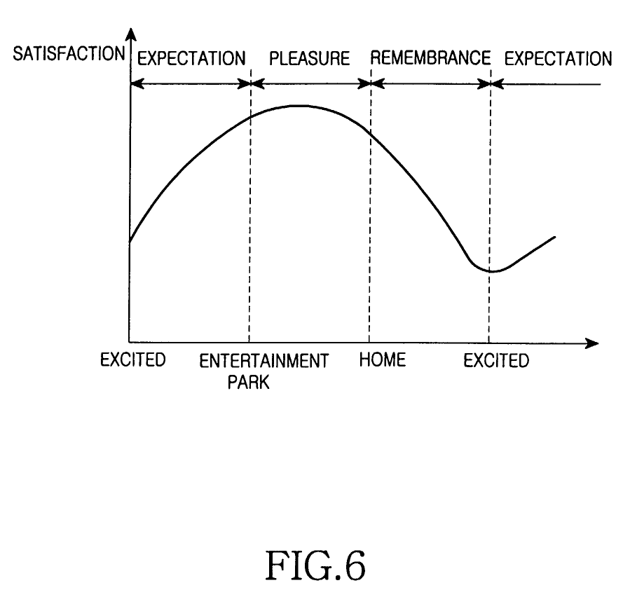

FIG. 6 is a graph illustrating variation in satisfaction associated with a visit to the entertainment park 200. As the graph shows, the present invention is enables maximizing satisfaction of a visitor to the park 200, as well as encouraging (via increased satisfaction and recollection of entertainment part experiences) him/her to return in a shorter period of time after he/she leaves the park 200.

As described above the present invention, enables various needs or sets of needs of a visitor to an entertainment park to be satisfied using souvenir-shaped coins. Consequently, the entertainment park becomes more attractive and differentiated from other parks. Further, in the present invention, the visiting time and spending of a visitor to the entertainment park increases, while maximizing the visitor's satisfaction and creating new demand. The visitor keeps the coin as a souvenir with his/her experiences in the entertainment park and recalls it to his/her memory, thereby being induced to visit the park again in a short time.

The following merely illustrates the principles of the invention. It will thus be appreciated that those skilled in the art will be able to devise various arrangements which, although not explicitly described or shown herein, embody the principles of the invention and are included within its spirit and scope. For example, the portable service device 204 may be classified into a low-end device for children and a high-end device for adult. For example, the low-end device may have a black-and-white display and not have the Bluetooth module 412, the kiosk connection unit 414 and a PIMS function, so that it can be provided at a low cost. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

The functions of the various elements shown in the FIGS. 2-4, including functional blocks labeled as “processors” and “controllers” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Their function may be carried out through the operation of program logic, through dedicated logic, through the interaction of program control and dedicated logic, or even manually, the particular technique being selectable by the implementer as more specifically understood from the context.

What is claimed is:

1. A device for providing services to a visitor to an entertainment park, the device comprising:
a memory device for storing content relating to at least one need of the visitor in the entertainment park; and
a connection unit for allowing access to the memory device from an external device.

2. The device as set forth in claim 1, wherein the content unit is souvenir coin shaped.

3. The device as set forth in claim 1, wherein the memory device is a semiconductor memory chip.

4. The device as set forth in claim 1, wherein the content is selected from the group consisting of entertainment park event information, entertainment park guide information, games, stories or storage memory for visitor specific data.

5. A portable service device for use by a visitor in an entertainment park, the portable service device comprising:
a content unit having a memory for storing at least one need of the visitor, wherein the need relates to a particular entertainment park service;
a content access unit for enabling visitor access to the content unit;
a data input/output unit for providing information to the visitor; and
a controller for controlling content access and data input/output in response visitor commands.

6. The portable service device of claim 5, wherein the data input/output unit includes image or audio signal input/output;

7. The portable service device of claim 6, wherein the data input/output unit includes outputting an image or audio signal or capturing image or audio signal for input to the portable service device.

8. The portable service device of claim 5, wherein the content is selected from the group consisting of entertainment park event information, entertainment park guide information, games, stories or storage memory for visitor specific data.

9. A system for providing services to a visitor to an entertainment park, comprising:
a content unit for storing content information, wherein the content information satisfies one of various needs of the visitor in the entertainment park; and
a portable service device including a content access unit for accessing the content unit provided in the portable service device, the portable service device providing the visitor with the content stored in the content unit in response to a command inputted from the visitor.

10. The system as set forth in claim 9, wherein the system further includes a kiosk for accessing the portable service device and providing content information to the portable service device.

11. The system of claim 9, wherein the visitor need is satisfied by accessing the content information, wherein the content information that is provided is selected from the group consisting of entertainment park event information, entertainment park guide information, games, stories or storage memory for visitor specific data.

12. The system of claim 9, wherein the system further comprises a Bluetooth base station for transmitting multimedia data using a Bluetooth communication.

13. The system of claims 9, further comprising:
a personal computer (PC) having a content access unit for allowing the PC to access the content unit.

14. A method for providing services to a visitor to an entertainment park, the method comprising:
storing in a portable memory device content relating to at least one need of the visitor in the entertainment park; and
accessing, by the visitor, the portable memory device to retrieve the content to satisfy the at least one need of the visitor.

15. The method of claim 14, wherein the content is selected from the group consisting of entertainment park event information, entertainment park guide information, games, stories or storage memory for visitor specific data.
